(19) United States
(12) Patent Application Publication
(10) Pub. No.: US 2025/0208913 A1
(43) Pub. Date: Jun. 26, 2025

(54) INVARIANTS-AS-CODE FOR SYSTEM UNDER TEST

(71) Applicant: BLUE ORIGIN, LLC, KENT, WA (US)

(72) Inventors: BENJAMIN JAMES DOUGLASS, KENT, WA (US); NICOLAS CHRISTOPHER HIMMEL, RENTON, WA (US); ALAN EDWARD BENGTSON, SEATTLE, WA (US); JOSHUA THOMAS MCGUIGAN, SEATTLE, WA (US)

(21) Appl. No.: 18/393,352

(22) Filed: Dec. 21, 2023

(51) Int. Cl. G06F 9/50

(52) U.S. Cl. CPC G06F 9/5027

(57) ABSTRACT

Systems and methods herein are for a system-under-test (SUT). A library is provided with different invariants-as-code (InaC) source code which is to be complied for verifying the SUT. The different InaC source code includes different invariant features defined at least by respective preconditions and input conditions. The SUT is to perform test procedures executed within a test environment to provide differently formatted data, from which uniformly formatted time series data is generated. One or more compiled versions of the different InaC source code is executed with one or more parts of the uniformly formatted time series data to provide results of the SUT. The results of the SUT represent at least one invariant which is continuous over a state of the SUT.

### TECHNICAL FIELD

Developments herein relate generally to a system under test (SUT) which may include space rocket components having software to perform various aspects of a launch, subject to validation prior to deployment.

### BACKGROUND

A space rocket typically includes a propulsion module and a capsule. One or more of the propulsion module or the capsule may include systems associated with control aspects. The control aspects may be coordinated by software, firmware, or hardware features. For example, a space rocket may include fuel-related control, flight control, landing control, among other control aspects. The software can be used to control vertical take-off and/or landing using one or more of the fuel-related control, flight control, or landing control.

The space rocket is also capable of autonomous flight missions. An autonomous flight mission can require autonomous launch, autonomous flight, and autonomous landing. As the autonomous part of the flight missions rely on robust software, the software described herein is subject to validation. An example validation or verification includes identifying test cases for each of multiple requirements to be performed by the software. The test cases can be used to verify or validate that each of the requirements has been implemented properly in the software. As such, each test case may identify preconditions corresponding to initial settings of variables. A test case may include inputs corresponding to transition of the variables to a different value and may include expected result(s). The expected results may be in the form of values expected for outputs from the test cases.

The software may include control invariants or extracted invariant features that may be parameters or that may be data that can be used to indicate testing results and that may be used in the verification of a system under test (SUT). The testing results may be determined using a monitoring process and may be determined at specific times or states for an SUT. However, this also implies that failures from other unknown states or other time periods, for unknown reasons, may not be logged or considered in the validation process.

### SUMMARY

In one example, a system herein includes at least one processor and memory having instructions which when executed by the at least one processor cause the system to perform functions for a system under test (SUT). The functions include to provide a library having different invariants-as-code (InaC) source code to be complied for verifying the SUT. The different InaC source code include different invariant features defined at least by respective preconditions and input conditions. A further function caused in the system is to enable the SUT to perform test procedures which are executed within a test environment to provide differently formatted data. The differently formatted data may be used to generate uniformly formatted time series data. A further function of the system is to execute one or more compiled versions of the different InaC source code with one or more parts of the uniformly formatted time series data. This provides verification results of the SUT that represent at least one invariant which is continuous over a state of the SUT.

In a further example, a system herein has at least one processor and memory with one or more compiled versions of different invariants-as-code (InaC) source code. The different InaC source code, when executed by the at least one processor, cause the system to perform at least part of a verification for a system-under-test (SUT). The system is caused to perform the part of the verification of the SUT using one or more parts of a uniformly formatted time series data. The verification is to provide verification results of the SUT which represent at least one invariant which is continuous over a state of the SUT. The state of the SUT includes verification results or represents verification results of testing conducted in a continuous manner. The verification may be performed against those test results from the SUT. For example, the uniformly formatted time series data is generated from differently formatted data provided from the SUT performing test procedures within a test environment. Further, the different InaC source code include different invariant features defined at least by respective preconditions and input conditions for the verification of the SUT.

In another example, one or more circuits herein are to verify a system-under-test (SUT). The verification uses execution of one or more compiled versions of different invariants-as-code (InaC). source code. The InaC source code is from a library. The verification also uses one or more parts of uniformly formatted time series data from the SUT performing test procedures in a test environment. The verification is to generate verification results of the SUT which represent at least one invariant which is continuous over a state of the SUT.

In yet another example, a method herein is for a system-under-test (SUT). The method includes providing a library having different invariants-as-code (InaC) source code to be complied for verifying the SUT. The different InaC source code include different invariant features defined at least by respective preconditions and input conditions. The method includes enabling the SUT to perform test procedures executed within a test environment to provide differently formatted data. The method includes generating uniformly formatted time series data from the differently formatted data. The method further includes executing one or more compiled versions of the different InaC source code with one or more parts of the uniformly formatted time series data to provide verification results of the SUT. The verification results represent at least one invariant which is continuous over a state of the SUT.

### BRIEF DESCRIPTION OF DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise.

FIG. 1 illustrates aspects of a space rocket having at least one system-under-test (SUT) to be subject to a test and a verification using different invariants-as-code (InaC) source code, according to at least one embodiment;

FIG. 2 illustrates environments for an SUT, according to at least one embodiment;

FIG. 3 illustrates stages for an SUT subject to testing and verification using different InaC source code, according to at least one embodiment;

FIG. 4 illustrates relationships between features associated with an example InaC source code, according to at least one embodiment;

FIG. 5 illustrates computing features of an environment for an SUT subject to verification using different InaC source code, according to at least one embodiment;

FIG. 6 illustrates further computing features of an environment for an SUT subject to verification different InaC source code, according to at least one embodiment;

FIG. 7 illustrates a process flow for an SUT subject to verification using different InaC source code, according to at least one embodiment; and

FIG. 8 illustrates a further process flow for an SUT subject to verification using different InaC source code, according to at least one embodiment.

### DETAILED DESCRIPTION

As used herein, a library may be a collection of different invariants-as-code (InaC) source code that are pre-defined code, scripts, or procedures to be complied for verification of a system-under-test (SUT). The verification may be to ensure that at least one invariant is continuous over a state of the SUT. Therefore, the InaC source code may be in Rust® format or may be in any other compiler-based programming language including but without limitation, C Lang®, Golang®, Python®, Elixir®, C#®, JavaScript®, PHP®, Swift®, Haskell®, Python®, Nim®, and Val®. Further, the InaC source code may include different invariant features defined at least by respective preconditions and input conditions. The SUT may represent a space rocket subject to hot-fire testing, a space rocket in a mission, or space rocket under a simulation. However, the SUT may include any processor-based system running or executing software, including systems that are used in other endeavors than space-related applications. Therefore, the verification or validation of an SUT herein may be specifically to software and may be generally to compatibility verification or validation between the software and an underlying processor-based system.

As used herein, an invariant feature may be in reference to a specific process or aspect under verification for an SUT. For example, when the SUT is a space rocket, an invariant feature may be a fuel valve status and may be subject to fuel-related control, flight control, or landing control, for the space rocket. Therefore, an invariant feature may be associated with an invariant that is part of the test, and a subsequent verification, to be performed for the SUT. As used herein, an invariant may be a condition or a value that is expected to be consistent during execution of the process or feature, for an SUT. For example, for the space rocket SUT, an invariant can reflect an open fuel valve or a closed fuel valve. Further, consistency of an invariant itself may be a type of invariant and may be required to be verified during testing of an SUT. The consistency can be used to indicate or confirm integrity of a software, a computer program, or an algorithm associated with the SUT. Another invariant for an SUT may be a property or an entity that is to remain unchanged for the SUT. Yet another example of an invariant for an SUT may be a logical test result that is expected of the SUT, or an assumption that has to be verified in a test result from a test performed on an SUT.

The SUT herein is to perform test procedures executed within a test environment to provide differently formatted data from the SUT. As used herein, a test procedure may be a script that includes commands for setting one or more stimulus in a test environment for the SUT. The test procedure may be part of an InaC source code. Separately, a verification script may be part of the InaC source code and may include commands for verifying expected result(s) (also referred to herein as expects) of the SUT against the test results from the testing performed for the SUT. Further, there may be one or more invariant features for each requirement of each aspect of the SUT. Therefore, the InaC source code includes different invariant features provided by different verification scripts. The use of the InaC source code allows for verification that at least one invariant is continuous over a state of the SUT, instead of monitoring the test results of an SUT at specific states and times.

The invariant features may also be defined at least by respective preconditions and input conditions. As used herein a precondition may be a prerequisite or initialization to be completed before executing the test procedures for the SUT. For example, a prerequisite configuration, settings of variables, state, or other setup may be needed for the SUT or an aspect of the SUT, prior to executing the test procedure for the SUT. As used herein, a condition may be an input and other variable that may be subject to a transition, by the test case, to a different value. Once the SUT performs the test procedures executed within a test environment, there are test results generated to be reviewed against expected results. The test results may provide differently formatted data. As used herein, the test results may be a form of values and the expected results may also be in the form of values that are expected for the SUT, following the test procedure. For example, based in part on the respective preconditions and input conditions, the results of the differently formatted data may be generated.

Further, uniformly formatted time series data may be generated from the differently formatted data. For example, the outputs from running or executing the test procedures may be differently formatted data but may be recorded in a time-ordered series of events to represent the uniformly formatted time series data. The uniformly formatted time series data is a format that can be processed by compiled versions of the different InaC source code. For example, one or more compiled versions of the different InaC source code may be executed and may use one or more parts of the uniformly formatted time series data to verify the test results of the SUT. The compiled versions of the different InaC source code may provide the different InaC source code in binary format. The binary format may be executed in a central processing unit (CPU) or a graphics processing unit (GPU). The outcome from the execution of the compiled versions of the different InaC source code represents at least one invariant which is continuous over a state of the SUT.

Therefore, at least one benefit of the different InaC source code used in verification of an SUT is that the test results generated by a testing performed may be provided in any format, such as a format suitable to the SUT, as described further subsequently herein. As such, the test results may be the differently formatted data. The ability to standardize the differently formatted data to generate the generate uniformly formatted time series data that may be stored in an event generator or collector module, prior to verification being performed. Further, one or more aspects of the event generator or collector module and an InaC source code module providing the InaC source code may be rely on network-based storage. After storage in the event generator or collector module, the InaC source code module is able to access the test results and is able to perform verification to provide verification results about a state of the SUT, over continuous periods. The standardization of format over a network is so that different aspects of the SUT, providing differently formatted data, can be processed by the InaC source code without manual intervention.

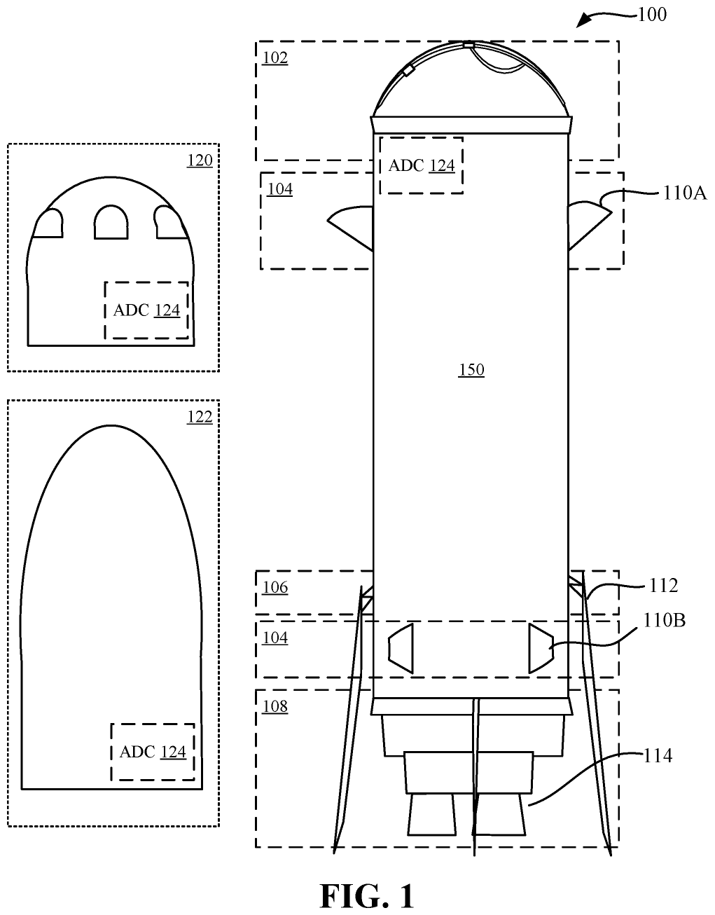

FIG. 1 illustrates aspects 100 of a space rocket having at least one system-under-test (SUT) to be subject to a test and a verification using different invariants-as-code (InaC) source code, according to at least one embodiment. Instead of a space rocket 100, however, the SUT may be a simulation of a space rocket or any other non-space application system having a processor and supported by software. As illustrated in FIG. 1, an SUT that is associated with a space rocket may be based in part on the propulsion module 150 that is subject to hot-fire testing, a space mission, or a simulation. The propulsion module 150 may include fuel-related control 102; flight control 104 via provided fins 110A, strakes 110B, or other wing-like provisions for lift and cross-range control during flight; landing control 106 via provided hydraulic-actuated legs 112 to support and secure a stage during landing; and engine control 108 via one or more thrusters 114. Each of these control aspects may be treated as an independent SUT that may be subject to different InaC source code for testing and to represent a verification of at least one invariant which is continuous over a state of the SUT.

Further, in FIG. 1, a re-entry capsule 120 or fairing 122 may be provided as part of the space rocket by attachment to the propulsion module 150. A re-entry capsule may include passengers for space tourism or space related work, whereas a fairing may include one or more satellites for orbit placement. Therefore, the illustrated propulsion module 150, along with the re-entry capsule 120 or fairing 122, may include features that may be subject to different SUT validation, and that may be readily performed using the discussion herein. A re-entry capsule or fairing may be part of a flight of the propulsion module 150 and may include a crew capability. The re-entry capsule or fairing may be atop the propulsion module 150. Therefore, the propulsion module 150 may be a rocket, such as a booster rocket. There may be a further components that may be ejected or dispensed from one or more of the propulsion module 150, a re-entry capsule, or a fairing. In one example, a propulsion module 150, a re-entry capsule, or a fairing may include an analog-to-digital converter (ADC) 124 that is to provide data acquisition from the propulsion module 150, the re-entry capsule, or the fairing performing a flight or from a simulation, or other procedures performed to collect data. Each or all of such propulsion module 100, re-entry capsule, and fairing may include SUTs subject to testing using different invariants-as-code (InaC) source, as described herein.

A flight of the propulsion module 150, with a re-entry capsule, may be a same or a similar flight of the New Shepard® suborbital vehicle by Blue Origin®. A flight of the propulsion module 150, with a fairing, may be a same or a similar flight of the New Glenn® suborbital vehicle by Blue Origin®. The New Shepard® suborbital vehicle may be the re-entry capsule whereas as fairing may not be capable of re-entry. Further, while able to perform re-entry from just beyond a Karman line, the re-entry capsule herein may be one that, without limitations, docks with a space station or performs space-related investigations, prior to re-entry and landing back on Earth's surface. The Karman line may be a reference point for an internationally recognized boundary of space that may be 100 kilometers or 330,000 feet above Earth's mean sea level.

In preparation for flight operations, preflight activities may be performed, which may the aforementioned mentioned SUTs testing and verification using different invariants-as-code (InaC) source. A further preflight activity may include loading of satellites and other components, upon confirmation of validity of all SUTs involved. In addition, the satellites or other components may include an ADC 124 loaded into a dispenser and may include the re-entry capsule (or a fairing) loaded to the propulsion module 150. The dispenser may be located a top portion of the propulsion module 150. The preflight activities may also include preparing one or more parachute systems to be loaded into respective containers of the respective components. Further, it is possible to also use data from the ADC 124 to provide data for verification of one or more SUTs of a subsequent space rocket, following a flight. This verification may be used with a subsequent flight that incorporates the one or more SUTs or improvements to the one or more SUTs.

The flight may begin with liftoff of a propulsion module 150 at a first time. Minutes later, such as, after a first time span and at a second time, the re-entry capsule or fairing separates from propulsion module 150. At or near a second time (e.g., just prior to, during, or just after rocket portion separation), a dispenser may eject the ADC 124 and other components, if loaded and ready for deployment therefrom, so that the ADC and the other components have the same or similar speed and trajectory (e.g., velocity) as re-entry capsule or fairing, which continues to climb past the Karman line. The ADC 124 and the re-entry capsule 120 may travel along a trajectory that allows for delayed re-entry or along any other trajectory for purposes of docking with a space station or performing other space-related investigations prior to re-entry. Meanwhile, the propulsion module 150 may fall back to Earth's surface, along a different trajectory, in a booster re-entry phase, eventually landing at third time.

Further, a second time span pertains to when the re-entry capsule or fairing and ADC eventually reach apogee (e.g., their maximum distance from Earth), during free-flight (e.g., sans rocket propulsion) in micro-gravity (hereinafter referred to by the approximation “zero-gravity”). Although, for other trajectories, there may be more time required to reach a suitable orbit or path to continue docking with a space station or for performing other space-related investigations prior to re-entry. For example, a satellite may be enabled, using the illustrated other trajectory, to reach a suitable orbit. For at least the second time span, an ADC may continue to be within a relatively close distance from the re-entry capsule or fairing. In one example, this distance may be less than 5 or 6 meters but could be other suitable distances, based at least in part on the application. Both, an ADC and re-entry capsule may be in zero-gravity for several minutes before falling back toward Earth and out of zero-gravity. However, some other components need not reach the zero-gravity threshold. The time period of several minute in zero-gravity is referred to herein as free-flight. After this period, both ADC and re-entry capsule begin to fall toward Earth and begin to encounter atmospheric drag. The fairing may deploy its satellites or other components to orbit and may not be capable of re-entry.

An ADC 124 may have a ballistic coefficient (e.g., 0.6 pounds per square inch (lb/in²)) greater than that of re-entry capsule to ensure that no in-flight contact can occur during re-entry. The ADC 124 may be configured to land before re-entry capsule 120, to also ensure no in-flight contact. Although for other components landing or re-entering after performing docking, investigations, other space missions, the landing herein may be directed to a single re-entry capsule or other singular component. The ADC, having a ballistic coefficient greater than that of re-entry capsule, may follow an ADC trajectory that is substantially different from a re-entry capsule trajectory of the re-entry capsule. These two trajectories may lead to an increasing separation distance and help to prevent the possibility of a collision between the two objects. The flight may end when re-entry capsule or other component, travelling along its intended trajectory, lands on Earth's surface at first landing time. The ADC, travelling along its trajectory, lands on Earth at second landing time. Each of the re-entry capsule and the ADC may use one or more parachutes to slow their descent. A further time span may separate the landing times of the propulsion module 150 and the ADC. Yet another time span may further separate the landing times of the ADC and of the re-entry capsule.

A re-entry capsule 120 may be used to carry equipment to and frame space, samples to space, samples from space, or crew or passengers. The re-entry capsule may be autonomously or remotely controlled so that only passengers are on board without the passengers requiring to control the re-entry capsule. Thus, the flight and the re-entry capsule may be configured for any suitable space mission, including for docking with a space station, for space investigation, sample recovery, deep space travel and return, space tourism, and rendering photography.

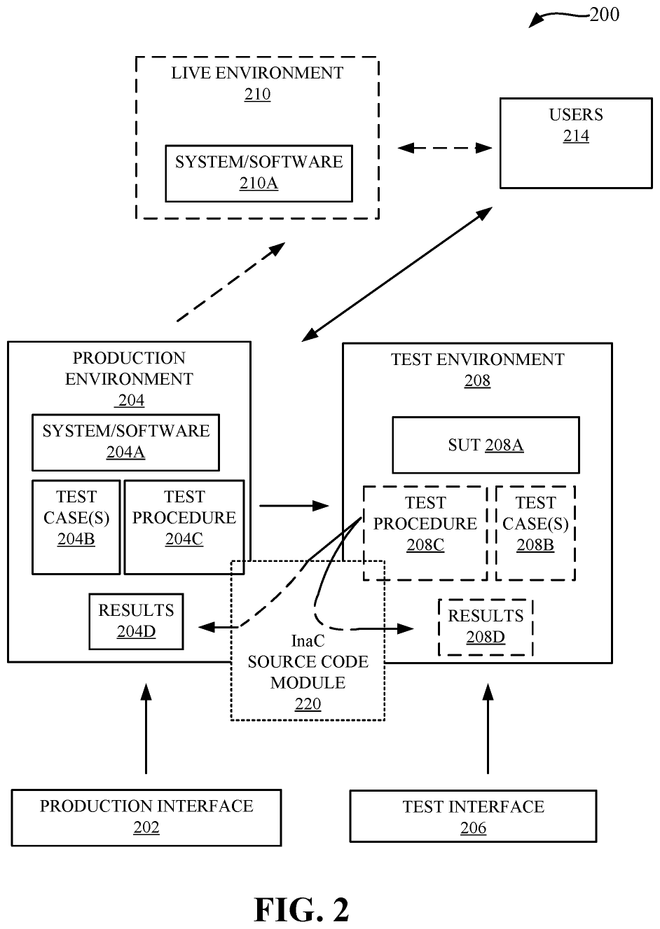

FIG. 2 illustrates environments 200 for an SUT, according to at least one embodiment. The environments 200 include at least a production environment 204 and a test environment 208. The environments 200 may include a separate live environment 210, relative to the production environment 204. The production environment 204 may be a continuously active environment in which software for a system operates for developers of the software and/or of the system. The production environment 204 may be accessed by developers through a provided and secure production interface 202. The production environment 204 may be scalable and secure for development but may not be stable. The production environment 204 is also subject to changes that may not be live for the SUT or for associated software of the SUT.

A live environment 210 may be different or may be a part of the production environment 204. However, the live environment 210 may include the system and/or software 210A that has qualified out of an SUT of a test environment 208. In an example, the live environment 210 may include the system and/or software 210A that is live and used by the intended users 214, including secure users or public users. In addition, the live environment 210 may be initially restricted to initial ones of the intended users 214, such as a beta testers or early adopters. In one example, however, a different the system and/or software 204A that is part of the production environment 204 may be restricted to the initial users, whereas the system and/or software 210A of the live environment 210 may not be restricted in this manner. In either case, the deployment in the live environment 210 or the production environment 204 is still distinct from deployment in a test environment 208. The live environment 210 may also be scalable and secure toward contributing to further developments of the system and/or software and may be more stable relative to the production or the test environment. The live environment 210 may be subject to limited changes in a system and/or software, once deployed, relative to the production environment 204.

A test environment 208 may be provided for testing and verification of the SUT 208A before a live version and/or a production version, represented as the system and/or software 204A; 210A, is deployed. In one example, however, the verification may be performed in the production environment and away from the test environment but using the test results from the test environment. For example, a production version of an SUT, represented as an initial system and/or software 204A, may be deployed in the production environment 204 for initial assessment. The live version is finally provided, represented as a different system and/or software 210A, to be deployed in the live environment 210 for beta testing and/or full use.

The test environment 208 may be isolated but may be a copy of a production environment 204 or a live environment 210. For example, one or more of hardware and platform software are similar between the test environment 208 and at least the production environment 204. This allows for detection of bugs, and other irregularities within an environment that closely fits the deployed hardware and platform software. Further, in view of the isolation, it is possible to provide different partitions within the test environment 208. There may be different versions of the SUT in each of the partitions. The test environment may be less secure and less stable, as a result. However, the test environment may be used to generate data from the SUT, based in part on the SUT performing test procedures executed within the test environment. The data corresponds to the differently formatted data and may be based on configurations associated with the preconditions and the conditions intended for the SUT.

FIG. 2 also illustrates that, for testing purposes, a test cases module 204B provides test cases generated by developers or testers. For example, the test cases module 204B may be used to identify a set of test cases for each requirement that will fully verify that the requirement has been implemented properly in software. Each test case provided in the test cases module 204B may identify preconditions, input conditions or inputs, and expected result(s). Therefore, the test cases module 204B may include storage capability and input capability. For example, the production interface 202 may be used to receive such preconditions, input conditions or inputs, and expected result(s). Further, the preconditions, input conditions or inputs, and expected result(s) may be in the form of values. At least the expected results are values that are expected for outputs of the results module 204D. In at least one example, one or more of the illustrated blocks 208B-208D are provided in broken lines to indicate that these may be in the test environment 208 instead of the production environment 204. In either environment, the illustrated blocks 204B-204D or 208B-208D perform the aspects described herein for verification of an SUT using different InaC source code.

Each test case may include a specific set of preconditions and conditions that may be provided to verify whether a particular feature or functionality of the SUT is working as expected. The test case may be part of a script of an InaC source code module 220. The script may include a test case identifier, may include a narrative or description that describes a functionality of the SUT being tested, may include the pre-conditions that may need to be satisfied prior to starting the test case, and may include test steps. The test steps may further include instructions to perform the test case. The script may also include the conditions that represent the specific input used during the test, and may include expected results to be anticipated in each test step of a test case.

Further, a test procedure of the test procedure module 204C may include a sequence or procedure steps of test cases that are provided together as a collection to achieve a test objective. For example, the SUT may include various related features or may have various parameters to be tested or validated to confirm working of the SUT. Like a test case, a test procedure may have a test procedure identifier, a narrative or description that describes the test objective, the pre-conditions that may need to be satisfied prior to starting the test case, the test cases to be included in the sequence or procedure steps, and the expected result that may be an overall expected result of the test procedure. The InaC source code separately performs verification of the overall expected result against the test results generated in the testing of the SUT, in view of the test objective. One or more of such test cases and test procedures may be provided from a test interface 206. For example, test users or tester may use the test interface 206 and may be able to provide test aspects, such as a values and narratives, for testing the SUT. The InaC source code module 220 is able to provide scripts that incorporate one or more aspects provided through the test interface 206.

In one example, the provided test cases module 204B and the test procedure module 204C may be used to identify a set of test cases for each requirement that will fully verify that the requirement has been implemented properly in software. Each test case can identify the preconditions as initial settings of variables, can identify the conditions as inputs to transition the variables of the preconditions to different values, and can identify the expected results in the form of values that are expected for outputs from the test case and the test procedure as a whole. In an example, the results module 204D; 208D may receive and store the test results from the test procedures. As illustrated in FIG. 2, instead of the production environment 204 including such modules 204B-204D, the test environment may have these modules 208B-208D that perform each as aspect of the test or verification of the SUT 208A, as described with respect to the production environment 204.

In one example, it is possible to develop test procedures that will exercise a software of an SUT in a portion of the test environment 208. This may be performed for the test cases, which may be in different portions of the test environment 208 than the portions that hold the one or more modules 208B-208D and the portions that provide the SUT. The test procedures can be a list of procedure steps to be executed or to be performed using automated test scripts that can be run without manual intervention using the InaC source code. In an example, the test procedures may be a mix of user provided test cases and automated test scripts having within it the different test cases.

The results module 204D; 208D may include test results from the test procedures and may also include verification results from the test results. For example, the results module may include PASS or FAIL status for teach test cases and for the test procedure. Therefore, the PASS or FAIL status indicates whether all test cases within a test procedure has passed or at least one that has failed. Further, the verification results may be based in part on the expected results of each test case in the test procedure, as verified against the test results from each test case. The information from the results module 204D; 208D may be used to isolate and provide further test-specific functionalities of the SUT. The information from the results module 204D; 208D may be used to identify bugs and defects in the SUT. The information from the results module 204D; 208D may be used to ensure that software of the SUT meets requirements and may be used to provide a baseline for future regression testing.

The test environment 208 may include hardware components, including components that a specific to an SUT, such as an electronic control unit (ECU) of a space rocket. The test environment 208 may include software that is purposed for the ECU, with the hardware and software being part of the SUT. In one example, the SUT may be actual or simulated components. One or more of the provided modules 204B-208D provide a way to set inputs, to record inputs, and to report outputs. For example, the test results of the results module 204D; 208D are recorded inputs and outputs for each test case from the test procedure being executed in the test environment. The test results may include expected values or may be verified against the expected values for all inputs and outputs. Therefore, the test results may include results that are evaluated to provide the PASS or FAIL status, as part of verification results, of each test case using the InaC source code.

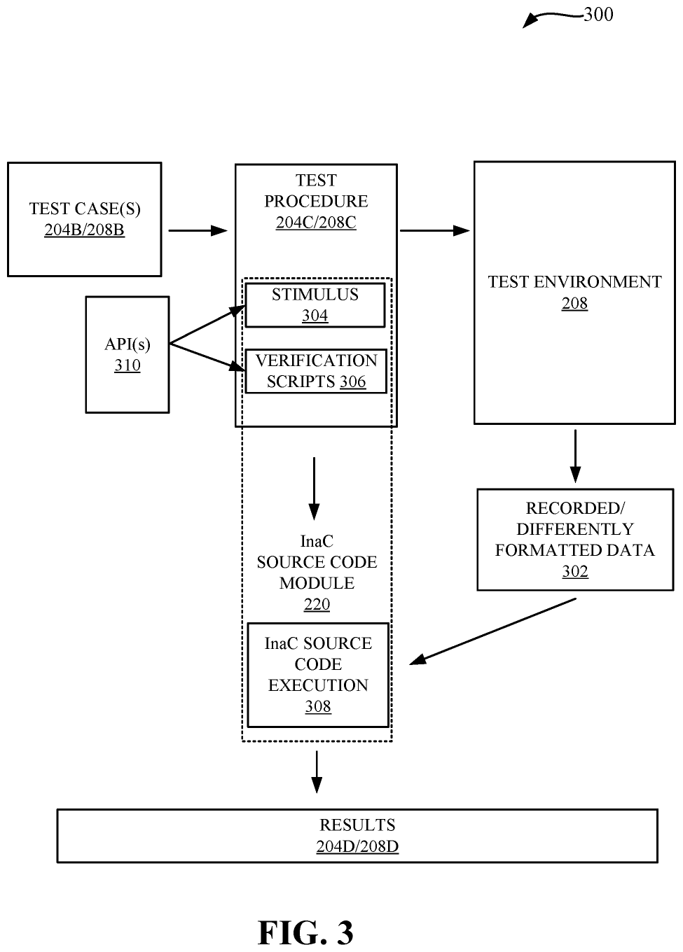

In at least one embodiment, to address limitations of a monitoring process or the use of specific times or states for test results of an SUT, an InaC source code module 220 is able to use a library of InaC source code that may be in Rust format or other suitable format to analyze output from the testing to provide verification of the test results from the results module 204D; 208D. While illustrated as a separate component, the InaC source code module 220 may include parts of the test procedures 204C; 208C. For example, as detailed further with respect to FIG. 3, the InaC source code module 220 may include verification scripts that are part of an InaC source code to perform the verification described herein but may also include parts of the scripts for providing the testing. To illustrate this, the InaC source code module 220 is provided as a block that is overlapping with the test procedures 204C; 208C.

The InaC source code module 220 may include storage for different InaC source code and may include compiled versions of the different InaC source code. The InaC source code module 220 may include processing capability to execute the compiled versions of the different InaC source code. The InaC source code, by its verification of the test results, may be used to make assertions about time series data that is reflective of the test results output from the test cases performed in an SUT. Further, the InaC source code allows a tester or other user of the system herein to produce programmatic statements that trace easily to requirements of the SUT. The InaC source code allows for programmatic statements that are easily understood by non-programmers, and that can be automatically verified against the output collected from the test procedure of the test procedure module 204C; 208C.

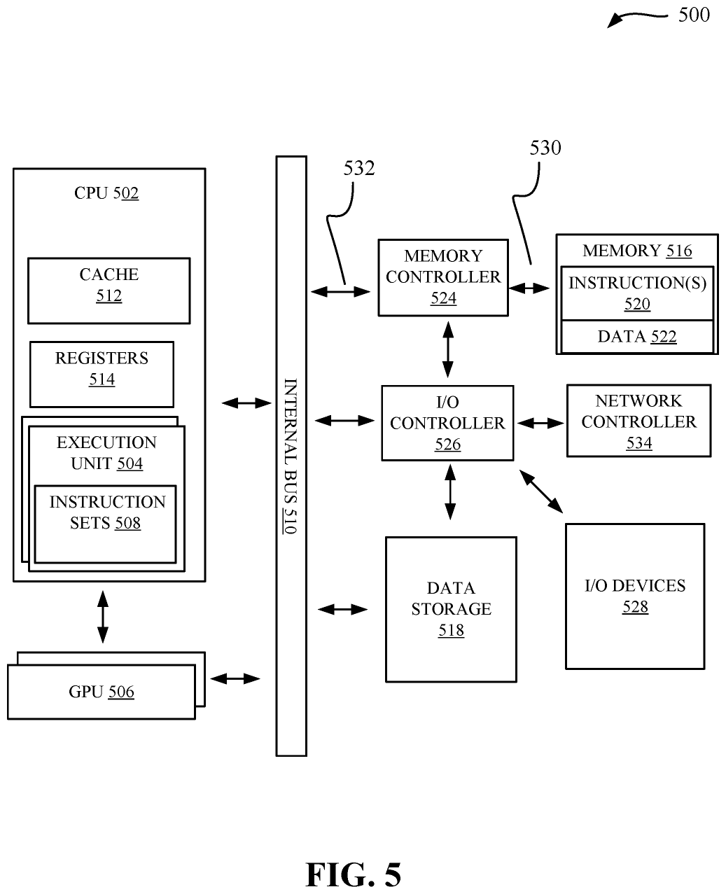

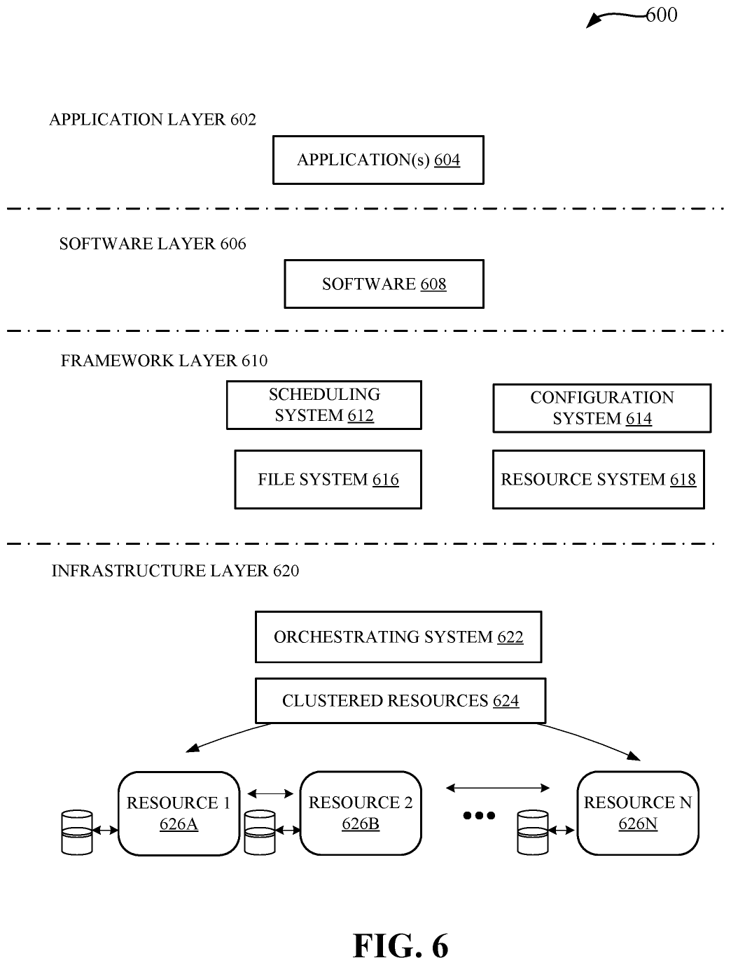

In one example, the InaC source code module 220 may also include processing capability that is within the production environment 204 or the test environment 208. The computing features of FIGS. 5 and 6 may provide the processing and other capabilities for the InaC source code module 220. The InaC source code module 220 can execute the compiled versions of the InaC source code to process the test results of the test procedures in a continuous manner. For example, the results of the test procedures may be continuously recorded as differently formatted data that is subject to conversion or generation of uniformly formatted time series data. In one application, the differently formatted data may be two different broad series of data, such as plant log data of a log database file (LDF) format or a comma separate value (CSV) format, that is to be converted into standard format. This may be caused to occur at a shared time stamp to ensure that the data is continuous and is based on a time series. Then, verification scripts of the InaC source code may verify the uniformly formatted time series data against expected results, for instance, to provide the test results for the results module 204D; 208D. As the test procedure may include an invariant, the verification results in the results module 204D; 208D of the SUT represent at least one invariant which is continuous over a state of the SUT.

In an example, the uniformly formatted time series data may be a time-ordered series of events that is output from executing test procedures on hardware in loop (HIL) features of a space rocket, representing the SUT. Further, the uniformly formatted time series data may be from different types of SUT, such as from a hot-fire of a space rocket, data from a mission (such as from a ADC of the mission), or data from a simulation. Consistent across all such SUTs is that test results are differently formatted data that may first be converted to the uniformly formatted time series data, which is a format understandable to the InaC source code, for instance.

In an example, the InaC source code may include different verification scripts representing implementations of test cases that are coded in Rust format. The InaC source code module 220 uses an application programming interface (API) to receive definitions of preconditions, conditions, and expected outputs for an SUT. The verification scripts may be collected in the InaC source code module 220 to provide the InaC source code. Further, the verification scripts may be organized as a set of coded modules, such as Rust-coded modules. Each coded module may include one or more functions. The functions may include one or more test cases. As such, the functions may represent a test procedure. Further, the SUT may be subject to requirements-based testing (RBT). The grouping of test cases for a given requirement into a function that provides a test procedure supports the RBT aspect for an SUT. Further, the functions of the test procedure may be related to the requirements that are grouped into the set of coded modules and provided by one or more of the InaC source code.

FIG. 3 illustrates stages 300 for an SUT subject to testing and verification using different InaC source code, according to at least one embodiment. In one instance, an SUT may be a controller software for airborne uses. Then, verification or validation of the controller software, enabled by the different InaC source code, may be according to standards in airborne systems (such as, DO-178). The verification or validation of a controller software may require setting a controller known state, setting up preconditions, triggering stimulus, and starting and monitoring behavior of the controller software using the InaC source code. Such standards may also require verification or validation that test results are as expected. However, the InaC source code is able to provide verification or validation that test results are as expected continuously over a state of the SUT.

The use of the different InaC source code herein is able to address limitations from certain SUT being monitored only at specific known time points or known states. For example, a limitation may be that verification or validation be performed at such time points or states that are known for each test case. This limitation causes most of the collected data from a controller performing the controller software to be discarded, with only about 2 or 3 bytes being used for the test results. To address this limitation, test cases 204B; 208B may be identified for each requirement. However, a test procedure 204C; 208C having the test cases 204B; 208B may be split into distinct components. For example, there may be a stimulus component 304, which only has steps required to initiate the preconditions and conditions, without performing the verification or validation. Therefore, the stimulus component 304 may be a storage component.

A further component of a test procedure 204C; 208C is a collection of verification scripts. The collection of verification scripts and the stimulus component 304 may also form part of the InaC source code module 220 and may be another part of the same storage as the stimulus component 304. In one example, the stimulus, the preconditions, and the conditions may be provided via one or more API(s) 310 to be part of the stimulus component 304 or the verification scripts 306. The stimulus, the preconditions, and the conditions may be included within an InaC source code as a Rust or other coded module. There may be multiple InaC source code, as a result, and may be directed to different test cases of a test procedure. The stimulus part of the InaC source code may be executed in the test environment 208, with the conditions of the stimulus applied to the SUT and with any output data of the SUT collected as recorded data or differently formatted data 302. At least the verification scripts of the InaC source code may be used to verify the test cases 204B; 208B

In an example, the verification scripts and recorded data may be passed into an InaC source code execution component 308 of the InaC source code module 220. The InaC source code execution component 308 is able to execute compiled versions of the InaC source code that may be stored in the InaC source code module 220. The execution of the compiled versions of the InaC source code, with one or more parts of the uniformly formatted time series data from the test procedures 204C; 208C, causes verifications that can be stored in a results module 204D; 208D. In one example, the verification results may include verifications or indications of state of the SUT, such as, that at least one invariant is continuous over a state of the SUT. As such, the verification or indication of the state may be a PASS, a FAIL, or an UNKNOWN states over different time points representing that the invariant is continuous over a state of the SUT. The state may be obtained at any point in time and may be continuously updated as the InaC source code is continuously executing. This is even as different parts of the uniformly formatted time series data is tested, verified, or validated by the InaC source code.

In at least one embodiment, the InaC source code module 220, having the components described all throughout herein, allows invoking of groups of test cases, such as a sequence of test cases forming part of a test procedure. The InaC source code module 220, having the components described all throughout herein, is also able to perform the testing and the verification in a dynamic manner. The dynamic manner is in reference to continuous and ongoing testing and verification performed for an SUT over different time periods and different states of the SUT. One or more invariants may be identified across the groups of test cases for an SUT. Therefore, execution of one or more compiled versions of the different InaC source code, through the InaC source code module 220, with one or more parts of the uniformly formatted time series data, can provide verification of the SUT. The verification represents that at least one of the invariants in the SUT is continuous (or constant) over a state of the SUT. In one example, the different InaC source code are continuously used over a predetermined period with the one or more parts of the uniformly formatted time series data. This allows the provision of the verification results of the SUT which represent the at least one invariant over the state of the SUT

In an example, a verification script 306 of an InaC source code may include a syntax such as in Table 1.

TABLE 1

```
verify(<description>)
  .given(<Condition>)
  .then(<Response Condition>)
```

The verify function of the verification script in Table 1 is supported by a given method and a follow-up then method. The verify function includes a text description parameter which may be a unique identifier for a test case and may be used to provide context or reference to a test result of the test case. The given method may include the preconditions and conditions described throughout herein. The then method specifies a response condition. The response condition represents a response of a software of an SUT to a condition of the given method. In an example, the verification script in Table 1 may be generated from provided preconditions and conditions for a test case. The verification script represents a logical test case, where “as long as a condition is true, then the response condition should be true.”

Therefore, as provided in Table 1, individual ones of the different InaC source code include a verify function. The verify function performs the verification using a given method and a follow-up method. The given method includes respective preconditions and input conditions. The follow-on then method specifies a further condition representative of an SUT response to at least one input condition of the respective preconditions and input conditions. The SUT response may be the response condition in Table 1.

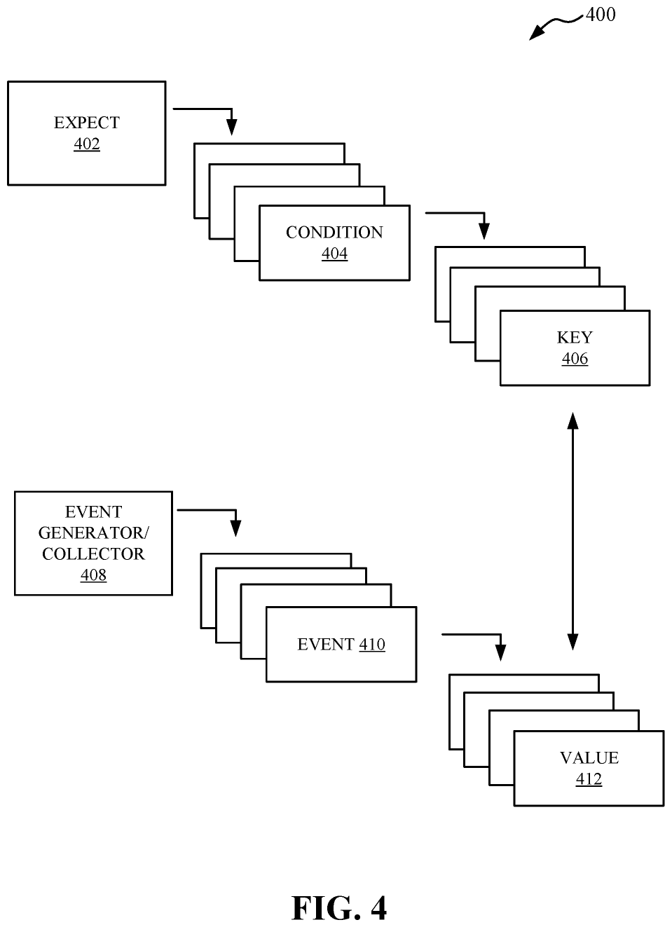

FIG. 4 illustrates relationships 400 between features associated with an example InaC source code, according to at least one embodiment. For example, in addition to the syntax in Table 1, the InaC source code may include an expect 402, which represents the expected value or output of the test of an SUT. The expect 402 describes invariants of an SUT and is expected to be true at all times. Further, a continuous expect may be suited to test cases where a requirement is to hold true continuously for a predetermined state of the SUT that may be different from a general state of the SUT. Separately, a triggered expect (also referred to herein as given-when-then expect) allows for expression of things, with respect to verification of an SUT. For example, the triggered expect may be triggered under a representative condition of “given that a controller is in <particular> mode, when a command is sent to go to a <different> mode, then the controller goes to <different> mode.”

Therefore, the InaC source code may include a complexity of assertions that can be made about the test results of a test applied to an SUT. There are basic conditions that can be evaluated, ranging from equality comparison as demonstrated in the examples above, to arbitrarily complex assertions about the test results by coding different verification script. The invariants at issue herein may be derived from a software of an SUT based in part on requirements of the SUT. For a controller software requirement, for instance, example invariants would be related to a requirement for such as condition as “while APP_MODE=Disabled, when commanded GOTO_MODE (Manual), then set APP_MODE to Manual”; or “convert analog-to-digital reading for temperature sensors to engineering units per provided equation.”

Further, in an example, the time series data herein may be telemetry that is provided by a controller, as well as commands sent to a controller. A controller may provide telemetry at a steady rate every few milliseconds. This telemetry may be a status update. In one example, the state update is that a “mode is autonomous, a temperature sensor <identifier> reads 213 units, main fuel valve is open 73%.” Such state update may be provided in the form of differently formatted data. The differently formatted data here may be ethernet packets. This differently formatted data may be converted to uniformly formatted time series data of events. The uniformly formatted time series data may be abstract data objects. The InaC source code module herein is able to take a stream of such events and is able to process them using different verification scripts, representing assertions or expects. This results in a verification that represents an assessment of whether a described invariant is continuous over a state of the SUT.

An expect may include multiple conditions 404. Further, a test case may include a single expect. Each of the conditions 404 may represent an assertion on one or more keys 406. As used herein, a key is used to represent a piece of data that may change over time, such as data that is not an invariant. Each of the keys 406 may be used as part of at least one of the conditions 404 to assert or check the state of a piece of data. For example, the data being invariant may be used as a reference that the invariant is not tainted.

A key may be of one of two categories, which may affect evaluation of conditions 404 used with the test case. For example, a cyclic key may be used to represent data that continuously has a value in a test case. For example, a cyclic key may be a chamber pressure or a valve sequence state for a space rocket subject to being an SUT. An acyclic key may be used to represent data that are commands and/or have a value that only has significance at a specific point in time when an event 410 occurs. For example, an acyclic key may be a commanded state in a GOTO_MODE command of an SUT. A GOTO_MODE command in an SUT may be used to wake a sensor or processor underlying the SUT. As used herein, an event 410 is an update to one of the values 412 of each of the keys 406. The update may occur at a specified point in time during performance of a test case. In one example, an event 410 may represent telemetry packets or operation command packets associated with an SUT.

Therefore, individual ones of the different InaC source code may include keys 406 for one of the respective preconditions and input conditions. Further, values 412 for the keys, may be determined during the execution of the one or more compiled versions of the different InaC source code. The values 412 may be determined using inputs or the conditions in the test procedure and using the uniformly formatted time series data. Further, the testing may be performed using the value for at least one of the respective preconditions and input conditions to provide at least part of the test results for the SUT, which is verified by the verification scripts of the different InaC source code.

The relationships 400 between features include relationships associated with test results and verification results, performed the InaC source code. For example, an event generator or collector 408 represents a collection of time series event data that may be the uniformly formatted time series data to be used with an InaC source code. Further, the uniformly formatted time series data may include multiple events 410. Each of the events 410 may include one or more values 412. Therefore, each of the expects may be evaluated in the context of every one of the events 410 in the event generator or collector 408. In addition, each of the values 412 correspond to each of the keys 406. An evaluation performed, by executing the InaC source code herein, feeds into the overall state (such as, PASS, FAIL, or UNKNOWN) that is associated with one or more expects 402, as it is a top-most feature of the relationships 400.

In an example application, the test cases 204B; 208B may provide recorded data or differently formatted data 302 as in FIG. 3. The recorded data may be converted into time series event data that is the uniformly formatted time series data of the event generator or collector 408. An API 310 may be used to provide keys 406 to relate the uniformly formatted time series data within different events 410. Then, compiled versions of the InaC source code may be executed to verify the uniformly formatted time series data against the expects. For example, the InaC source code may be executed with the uniformly formatted time series data to provide verification of the SUT, which represent at least one invariant which is continuous over a state of the SUT.

In a further example application, a configuration file may be provided with the InaC source code module 220. The configuration file maps parts of the uniformly formatted time series data with the different invariant features of the different InaC source code to perform the testing of the SUT. For example, the configuration file may include a mapping that is indicative of portions of the event generator or collector 408 to be evaluated against each expect of an InaC source code. The configuration file may include identification of function names for every requirement to be tested and may include associated information of the requirement or the test case. The associated information may also include the expected state, such as the PASS, FAIL, or UNKNOWN state for the requirement, as a whole. In an example, the API 310 in FIG. 3 may be provided to receive the configuration file. The API 310 can also receive the uniformly formatted time series data to perform the testing of the SUT. As the testing uses the configuration file and the uniformly formatted time series data in the test environment, the test results of the testing may be verified in the test environment or a production environment by executing the one or more compiled versions of the different InaC source code having the different verification scripts.

FIG. 5 illustrates a computing features 500 of an environment for an SUT subject to verification using different InaC source code, according to at least one embodiment. For example, the computing features 500 may be used to perform one or more aspects of the test environment 208 or the production environment 204. Therefore, the computing features 500 can support an InaC source code module to retain stimulus, preconditions, and conditions, and to provide scripts that can be compiled to provide compiled versions of different InaC source code. Further, the computing features 500 can support execution of the different InaC source code to perform the verification described throughout herein.

The computing features 500 may be connectable to any SUT or may be connectable to receive an SUT, such as a part of a propulsion module. For example, one or more of the computing features 500 may be individually connectable to part of a fuel-related control, a flight control, landing control, and engine control. This is so that each of these control aspects may be treated as an independent SUT that is subject to verification by the computing features 500. However, in the case of simulation, the computing features 500 may run the simulation or may support a virtual machine to run the simulation. Further, the central processing unit (CPU) 502 may include one or more execution units 504 to perform any of the modules 204A-204D; 208A-208D that are associated with or that support the InaC source code module 220 described herein.

The execution units 504 may include multiple circuits to support the InaC source code module 220. The CPU 502 may be a special-purpose processor that is associated with one or more GPUs 506 to coordinate activities for the testing of an SUT. Therefore, one or more circuits of the computing features 500 are able to test and verify an SUT using execution of one or more compiled versions of different InaC source code from a library. The test and verification may include using one or more parts of uniformly formatted time series data from the SUT performing test procedures in a test environment. The verification to generate verification results of the SUT which represent at least one invariant which is continuous over a state of the SUT.

Further, the one or more circuits of the computing features 500 is able to provide an API through which to receive a configuration file. The configuration file, as described with respect one or more of FIGS. 2-4, maps parts of the uniformly formatted time series data with different invariant features of the different InaC source code. The one or more circuits of the computing features 500 can also provide the API, through which it is possible to receive the uniformly formatted time series data to perform the verification of the SUT. The verification uses the configuration file and the uniformly formatted time series data in the test environment. For example, the execution of the one or more compiled versions of the different InaC source code is performed in the test environment to provide the verification.

The computing features 500 may be performed by a system-on-a-chip (SOC), or some combination thereof, formed within a CPU 502. The CPU 502 may include execution units 504, as illustrated. The CPU 502 is able to execute instructions from one or more instruction sets 508. The instructions may enable a compiler and may enable execution of the compiled versions of the InaC source code. The CPU 502 includes support for logic in its execution units 504. The logic may be used to perform algorithms for processing. Further, the CPU 502 and the GPUs 506 include support for performing binary code, such as from the compiled versions of the InaC source code. Therefore, one or more of the CPU 502 or the GPUs 506 can perform the execution of one or more compiled versions of the different InaC source code with one or more parts of the uniformly formatted time series data. The one or more of the CPU 502 or the GPUs 506 can provide verification results of the SUT which represent at least one invariant which is continuous over a state of the SUT.

In an example, an execution unit 504 may include logic to perform integer and floating point (FP) operations. The execution unit 504 may be within the one or more of the CPU 502 or the GPUs 506. However, there may be multiple execution units 504 that may be coordinated to perform distributed computing features of the testing described herein. Further, one or more of the CPU 502 or the GPUs 506 may include a microprocessor code from a read only memory (ROM) for performing macro-instructions. An execution unit 504 of one or more of the CPU 502 or the GPUs 506 may include logic to handle one or more different types of instruction sets 508.

The one or more different types of instruction sets 508 may include an instruction set of a special-purpose processor, along with associated circuits to execute instructions therefrom. Further, operations caused by the instructions may be used by the testing related modules described herein. There may be packed data in the one or more of the CPU 502 or the GPUs 506 which may be used with the instructions to provide the operations. The testing related modules herein, as in at least FIG. 2, may be subject to acceleration and may be executed efficiently using a full width of an internal bus 510.

The execution unit 504 may be provided via microcontrollers, embedded processors, or other components of the CPUs, GPUs, or DPUs. However, the execution unit 504 may be other types of logic circuits than provided in such CPUs, GPUs, or data processing units (DPUs). The computing features 500 may include a memory 516 that is external to the one or more of the CPU 502 or GPUs 506 but that is coupled to the one or more of the CPU 502 or GPUs 506 via a high speed internal bus 510. This memory 516 may be a Dynamic Random Access Memory (DRAM), a Static Random Access Memory (SRAM), a flash memory, or any other memory capable of working with the one or more of the CPU 502 or the GPUs 506 and with the high speed internal bus 510. The memory 516 is distinct from a further data storage 518 that may be used for long term storage. The memory 516 may include instruction(s) 520 and/or data 522. One or more of the instructions or data may be run or executed by the one or more of the CPU 502 or the GPUs 506. The memory may be accessible via a memory controller 524.

In one example, the CPUs 502 of the computing features 500 may include any of a PENTIUM® Processor family from Intel®, including Itanium®, XScale™ and/or StrongARM™; Intel's Core™, Nervana™, or Xeon™ based processors. However, other CPUs, such as AMD®'s Ryzen series, Intel's Core i series, Qualcomm®'s Snapdragon® series, and Samsung®'s Exynos series may also be used. In a further example, the computing features 500 may include GPUs 506, such as from NVIDIA®'s GeForce series or AMD®'s Radeon series.

Further, systems of computers may form part or all of the computing features 500 and may have other types of processors than listed above. These computers may be workstations, set-top boxes, or have similar computing capabilities as these devices and may also be used to perform aspects of the system and method of FIGS. 1-4 herein. The computing features 500 may run or execute aspects of an operating system, such as UNIX®, Linux®, or WINDOWS®, and can perform embedded software, as well as support different types of user interfaces, including graphical user interfaces (GUI).

The computing features 500 may be provided via fixed and mobile devices. These devices include personal computers, workstations, handheld devices, virtual devices, or datacenters. Some examples of mobile devices include laptops, cellular phones, smartphones, Internet Protocol (IP) devices, digital cameras, personal digital assistants (“PDAs”), and other handheld PCs. The computing features 500 may be performed on virtual devices that are supported by embedded applications. The embedded applications may include a microcontroller, a digital signal processor (DSP), an SOC, network computers, network hubs, switches, routers, gateways, or any other system that may perform one or more instructions described herein.

The computing features 500 may be supported by one or more of the CPU 502 or the GPUs 506 that may include a complex instruction set computer (CISC) microprocessor, a reduced instruction set computing (RISC) microprocessor, a very long instruction word (VLIW) microprocessor, a processor capable of combining instruction sets, or any other processor device. Further examples of a processor device is an application specific integrated circuit (ASIC), a DSP, or a DPU. As illustrated in FIG. 5, one or more of the CPU 502 or the GPUs 506 may be associated together and may be associated with other components using a high speed internal bus 510. The high speed bus 510 is capable of transmitting data and commands between the one or more of the CPU 502 or the GPUs 506 and between other components in the illustrated computing features 500.

The one or more of the CPU 502 or the GPUs 506 may include cache type memory. For example, one or more of the CPU 502 or the GPUs 506 may include a Level 1 (L1) internal cache memory (cache) 512. In a further example, the one or more of the CPU 502 or the GPUs 506 may include one or more internal cache. A multiple cache arrangement may be provided as a hierarchy or as levels of internal cache. As used herein, a cache is a type of memory that may reside internally or externally relative to each of the one or more of the CPU 502 or the GPUs 506. There is also possibility for a combination of an internal and external cache based in part on an application of the computing features 500. Further, the one or more of the CPU 502 or the GPUs 506 may include a registry or a register 514. The registry or register may be a file structure to retain different types of data. For example, there may be different types of the registry or registers. These may include integer registers, floating point (FP) registers, status registers, and an instruction pointer register.

A system logic chip capable of performing as the memory controller 524 may be provided between to a high speed internal bus 510 and the memory 516. The memory controller 524 and the one or more of the CPU 502 or the GPUs 506 may communicate via the high speed internal bus 510 using a high bandwidth memory path. This allows the one or more of the CPU 502 or the GPUs 506 to access the instruction(s) 520 and the data 522 for performing the testing described herein. The memory controller 524 may also be able to direct signals of data between one or more of the CPU 502 or the GPUs 506, the memory 516, and other components in the computing features 500.

In addition to the above, the memory controller 524 may also bridge signals of data between a high speed internal bus 510, a memory 516, and an input/output (I/O) controller 526. The memory controller 524 may include different types of ports, including ports for interfacing with one or more of the CPU 502 or the GPUs 506. At least one of the GPUs 506 may perform as a graphics controller for one of the input/output (I/O) device 528 which may include a display. The memory controller 524 may be associated with the memory 516 through a memory path 530 that is high bandwidth memory path. Although illustrated as coupled together via a high speed internal bus 510, the memory controller 524 may be coupled to one of the GPUs 506 via an Accelerated Graphics Port (AGP) interconnect 532. One or more of the CPU 502 may be coupled to one or more of the GPUs 506 directly or indirectly via a peripheral component interconnect express (PCIe®) interconnect standard. In addition, a network controller 534 may also be coupled to one or more of the CPU 502 or the GPUs 506 via a different interface that is also a PCIe interconnect standard. Further, some or all of the interconnected devices or chips herein may be provided via SOC. Therefore, some or all of the interconnected devices of FIG. 5 may be interconnected with proprietary interconnects. However, some or all of the interconnected devices of FIG. 5 may be interconnected by a combination of standardized interconnects (such as, PCIe and compute express link or CXL®) and the proprietary interconnects.

The computing features 500 herein may use the I/O controller 526 as a proprietary interface to bring together the memory controller 524, the network controller 534, and one or more of the other I/O devices 528. One or more of the controllers herein may include direct connections to some I/O devices 528 via a local I/O bus that may include a high-speed I/O bus for connecting peripherals to a memory 516, a chipset, and to one or more of the CPU 502 or the GPUs 506. The I/O devices 528 may include an audio controller, a firmware hub (such as a, a basic input/output system or BIOS), a transceiver, the data storage 518, a display, and any I/O controllers. The I/O controllers 526 may include input devices, including a keyboard interface, a mouse interface, a touch interface, a gesture interface, and one or more expansion ports, including a Universal Serial Bus (USB) port. The data storage 518 may include a flash memory storage, a hard disk drive, or any removable non-transitory storage media having instructions thereon. For example, a CD-ROM device, a flash memory device, or other mass storage device.

FIG. 6 illustrates further computing features 600 of an environment for an SUT subject to verification using different InaC source code, according to at least one embodiment. Like in the case of FIG. 5, the further computing features 600 herein may be used to perform one or more aspects of the test environment 208 or the production environment 204. Therefore, the further computing features 600 may be connectable to part of a propulsion module. For example, the further computing features 600 may be individually connected to part of a fuel-related control, a flight control, landing control, and engine control. This is so that each of these control aspects may be treated as an independent SUT that is subject to verification by the further computing features 600. Differently than FIG. 5, one or more parts of the further computing features 600 may be provided remotely, such as, by a data center or other virtual environment performing over physical resources. This enables testing of an SUT to be partly performed in a cloud environment, for instance.

In one example, a data center may include one or more of the further computing features 600 of FIG. 6. The further computing features 600 may include an application layer 602, a software layer 606, a framework layer 610, and an infrastructure layer 620. One or more of such layers may be enabled by a physical or logical separation. The logical separation may be provided by secure environments of the data center and may be supported by networking devices, including gateways, routers, and switches. The physical separation may be enabled by one or more of the illustrated resources 626A-626N being at different physical locations and supported by the networking devices.

In one example, the application layer 602 may include one or more application(s) 604 that may be associated with the API(s) 310 to perform the testing of an SUT described throughout herein. Within the application layer 602, one or more types of applications may be used by an SUT to generate output and may be used by an InaC source code module to provide verification of the output. Further, the applications may be performed using one or more portions of the illustrated individual resources 626A-626N, the clustered resources 624, and/or the orchestrating system 622 of the infrastructure layer 620. The application layer 602 may be user-facing.

The software layer 606 may include one or more different software 608 or portions thereof, that are also performed using one or more portions of the illustrated individual resources 626A-626N, the clustered resources 624, and/or the orchestrating system 622 of the infrastructure layer 620. However, the one or more different software 608 may be an operating system or a shell that may be deployed or that use on one or more of the resources or the file system described herein. Therefore, an application 604 of an application layer 602 may be performed within the software layer 606 or may use a software of the software layer 606. The software 608 may additionally include drivers, search software, scan software, database software, and other content software to perform an application.

The framework layer 610 may include one or more frameworks that support the software 608 of a software layer 606. The framework layer 610 may also include at least one framework that supports application(s) 604 of the application layer 602. As such, there may be a single framework or multiple frameworks to support one or more of the software 608 or the application(s) 604. The software 608 or the application(s) 604 may include web service software or web service applications. A web service software or application may be as provided by Google®'s Cloud®, Microsoft®'s Azure®, or Amazon® Web Services. The framework layer 610 may include web service frameworks, including Apache Spark®. A file system 616 of a framework having Apache Spark® may utilize a file system 616 that may be a distributed file system adapted for large data processing. Further, the framework layer 610 may include a configuration system 614 and a resource system 618.

The framework layer 610 may include a scheduling system 612, a configuration system 614, and a resource system 618, in addition to the file system 616. The scheduling system 612 may include drivers that may be used to schedule deployment of a workload, such as for SUT testing and/or verification. The workload may also be performed using the resources 626A-626N and may be also supported by other layers of the further computing features 600 herein. A configuration system 614 may be provided for configuring the different layers herein. A resource system 618 may be provided for controlling a clustering or grouping of the individual resources 626A-626N or of the clustered resources 624, which may be mapped to or allocated in support of a file system 616. A scheduling system 612 may be used to support scheduling of the workloads with the individual resources 626A-626N or with the clustered resources 624. The resource system 618 may work with an orchestrating system 622 of the infrastructure layer 620 to control the mapping mapped or allocated resources.

An infrastructure layer 620 herein may include the orchestrating system 622, the clustered resources 624, and the individual resources 626A-626N. The individual resources 626A-626N may include CPUs, GPUs, DPUs, or other processors adapted for performing the environments in FIG. 2, for instance. The other processors may be field programmable gate arrays (FPGAs) and process accelerators. The individual resources 626A-626N may include memory devices (such as, dynamic ROM and RAM), storage devices (such as, solid state, optical, or magnetic storage), network devices (such as gateways, routers, and switches), and virtual machines (VMs). However, it is also possible to include power modules and cooling modules as part of the individual resources 626A-626N.

Further, the clustered resources 624 may be two or more of such individual resources 626A-626N. A cluster resource may include a complete server having processing, memory, communication, power, and cooling resources working together to perform a workload. In addition, an orchestrating system 622 may be able to perform self-controlling actions based at least in part on data or data types associated with the workload. The self-controlling actions may be to avoid underutilization of resources or may be to change resources having less than optimal performance of a workload, for instance.

The clustered resources 624 herein may include separate groupings of the individual resources 626A-626N. The individual resources 626A-626N may be physically provided within one or more racks or server trays that may be part of a data center having the further computing features 600 herein. As such, one or more of the illustrated further computing features 600 may be located in physically distinct locations. Separate groupings of individual resources 626A-626N, provided within clustered resources 624, can enable computing, networking, and storage and other parts of the individual resources 626A-626N to used to support one or more workloads. For example, aspects of the individual resources 626A-626N may be configured or allocated to a clustered resources 624 that performs a workload. The individual resources 626A-626N may include CPUs, GPUs, DPUs, or other processors which may be clustered within one or more or server trays as part of the clustered resources 624 herein. The racks or server trays may be additionally associated with one or more of power modules, cooling modules, or network switches from the infrastructure layer 620.

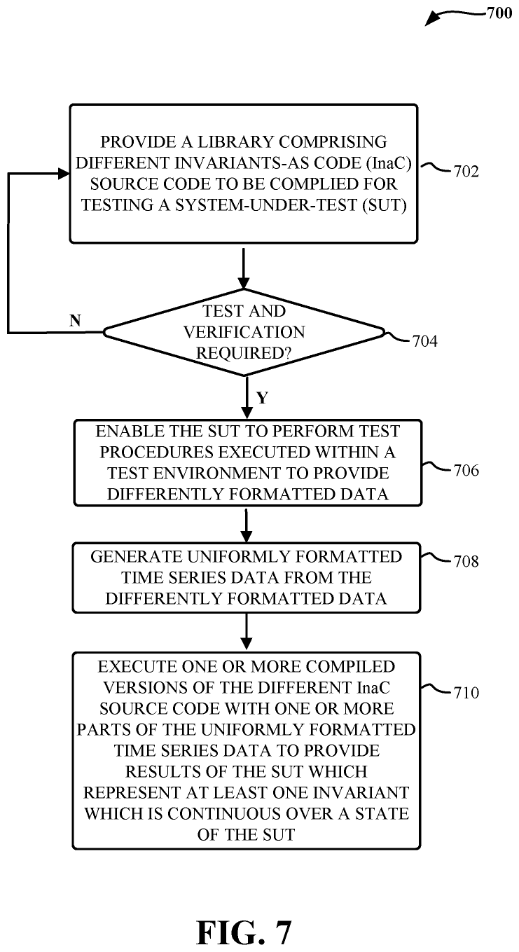

FIG. 7 illustrates a process flow or method 700 for an SUT subject to verification using different InaC source code, according to at least one embodiment. The method 700 includes providing 702 a library having different invariants-as-code (InaC) source code to be complied for verifying an SUT. The different InaC source code may include different invariant features defined at least by respective preconditions and input conditions, as provided in the example syntax of Table 1. The method 700 includes verifying 704 that testing and verification of an SUT is required. In an example, the verifying 704 may be performed by monitoring for a request or may be performed by inputs to a system or environment having the InaC source code module. The verifying 704 may be performed by an instruction or response to an API, for instance. The method 700 includes enabling 706 the SUT to perform test procedures executed within a test environment to provide differently formatted data.

Further, the method 700 includes generating 708 uniformly formatted time series data from the differently formatted data. The method 700 includes executing 710 one or more compiled versions of the different InaC source code with one or more parts of the uniformly formatted time series data. As a consequence, the method 700 is able to provide verification results, as part of the executing 710 step, of the SUT which represent at least one invariant which is continuous over a state of the SUT.

Further, in the method 700 herein, individual ones of the different InaC source code can include a verify function to verify a given method having the respective preconditions and input conditions. The verification uses a follow-on method which specifies a further condition representative of an SUT response to at least one of the input conditions of the respective preconditions and input conditions. Still further, in the method 700 herein, different InaC source code are continuously used over a predetermined period with the one or more parts of the uniformly formatted time series data. This enables the provision of verification results of the SUT which represent the at least one invariant over the state of the SUT.

In the method 700 in FIG. 7, individual ones of the different InaC source code may include keys for one of the respective preconditions and input conditions. The keys may include cyclic keys which have first values of the uniformly formatted time series data. The first values of the uniformly formatted time series data may be continuously provided in the test procedures. The keys may include acyclic keys which include second values of the uniformly formatted time series data. The second values of the uniformly formatted time series data are periodically provided in the test procedures.

In the method 700 in FIG. 7, the respective preconditions and input conditions are associated with assertions in one or more keys. In addition, the respective preconditions and input conditions may correspond to events in the uniformly formatted time series data. Further, the execution of the one or more compiled versions of the different InaC source code with one or more parts of the uniformly formatted time series data can provide the verification results of the SUT by a verification of data of the assertions against values from the events.

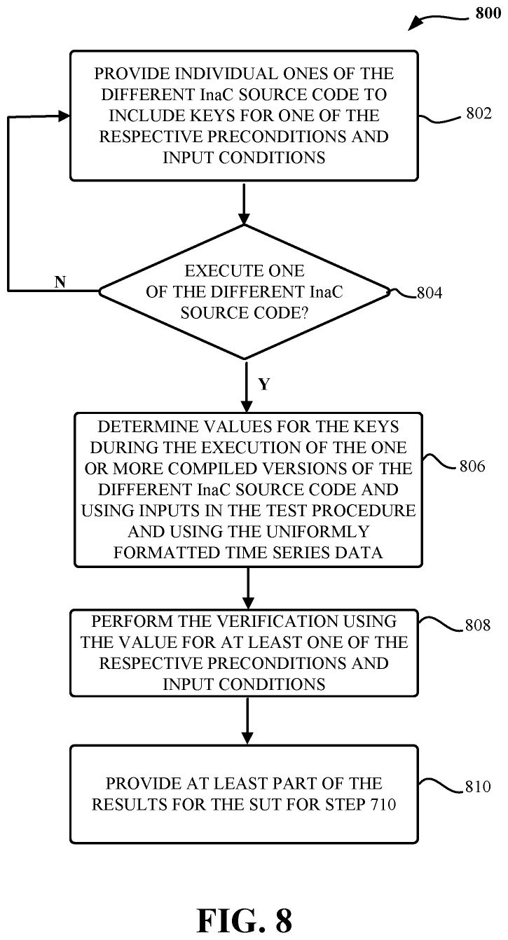

FIG. 8 illustrates a further process flow or method 800 for an SUT subject to verification using different InaC source code, according to at least one embodiment. The method 800 includes providing 802 individual ones of the different InaC source code with keys for one of the respective preconditions and input conditions. The method 800 includes verifying 804 to execute one of the different InaC source code. For example, an instruction may be provided through an API to initiate execution of one of the different InaC source code. Otherwise, the input of a stimulus and/or of the respective preconditions and input conditions may be sufficient to initiate execution of one of the different InaC source code.

The method 800 includes determining 806 values for the keys during the execution of the one or more compiled versions of the different InaC source code. The values may be determined using inputs in the test procedure and using the uniformly formatted time series data. The method 800 includes performing 808 the verification using the value for at least one of the respective preconditions and input conditions. The method 800 includes providing 810 at least part of the test results for the SUT, which may be based on the performing step 808. Further, the verification results of the SUT may correspond to the verification in step 710 of FIG. 7.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Use of terms “a” and “an” and “the” and similar referents in context of describing embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A system comprising:
at least one processor and memory comprising instructions which when executed by the at least one processor cause the system to:
provide a library comprising different invariants-as-code (InaC) source code to be complied for verifying a system-under-test (SUT), the different InaC source code comprising different invariant features defined at least by respective preconditions and input conditions;
enable the SUT to perform test procedures executed within a test environment to provide differently formatted data;
generate uniformly formatted time series data from the differently formatted data; and
execute one or more compiled versions of the different InaC source code with one or more parts of the uniformly formatted time series data to provide results of the SUT which represent at least one invariant which is continuous over a state of the SUT.

2. The system of claim 1, wherein individual ones of the different InaC source code comprise a verify function to verify a given method comprising the respective preconditions and input conditions using a follow-on method which specifies a further condition representative of an SUT response to at least one of the input conditions of the respective preconditions and input conditions.

3. The system of claim 1, wherein individual ones of the different InaC source code comprise keys for one of the respective preconditions and input conditions and wherein the instructions which when executed by the at least one processor further cause the system to:
determine values for the keys during the execution of the one or more compiled versions of the different InaC source code which comprises the individual ones of the InaC source code, the values determined using inputs in the test procedure and using the uniformly formatted time series data; and
perform the verification using the value for at least one of the respective preconditions and input conditions to provide at least part of the results for the SUT.

4. The system of claim 1, wherein the instructions which when executed by the at least one processor further cause the system to:
provide a configuration file which maps parts of the uniformly formatted time series data with the different invariant features of the different InaC source code to perform the verification of the SUT.

5. The system of claim 4, wherein the instructions which when executed by the at least one processor further cause the system to:
provide an application programming interface (API) to receive the configuration file and to receive the uniformly formatted time series data to perform the verification of the SUT, wherein the verification uses the configuration file and the uniformly formatted time series data in the test environment which performs the execution of the one or more compiled versions of the different InaC source code.

6. The system of claim 1, wherein the different InaC source code are continuously used over a predetermined period with the one or more parts of the uniformly formatted time series data to provide results of the SUT which represent the at least one invariant over the state of the SUT.

7. The system of claim 1, wherein individual ones of the different InaC source code comprise keys for one of the respective preconditions and input conditions, and wherein the keys comprise cyclic keys which comprise first values of the uniformly formatted time series data which are continuously provided in the test procedures and comprise acyclic keys which comprise second values of the uniformly formatted time series data which are periodically provided in the test procedures.

8. The system of claim 1, wherein the respective preconditions and input conditions are associated with assertions in one or more keys and correspond to events in the uniformly formatted time series data, and wherein the execution of the one or more compiled versions of the different InaC source code with one or more parts of the uniformly formatted time series data is to provide the results of the SUT by a verification of data of the assertions against values from the events.

9. A system comprising at least one processor and memory comprising one or more compiled versions of different invariants-as-code (InaC) source code which when executed by the at least one processor cause the system to:
perform part of a verification of a system-under-test (SUT) using one or more parts of a uniformly formatted time series data to provide results of the SUT which represent at least one invariant which is continuous over a state of the SUT, the uniformly formatted time series data generated from differently formatted data provided from the SUT performing test procedures within a test environment, wherein the different InaC source code comprise different invariant features defined at least by respective preconditions and input conditions for the verification of the SUT.

10. The system of claim 9, wherein individual ones of the different InaC source code comprise a verify function to verify a given method comprising the respective preconditions and input conditions using a follow-on method which specifies a further condition representative of an SUT response to at least one of the input conditions of the respective preconditions and input conditions.

11. The system of claim 9, wherein the different InaC source code are continuously used over a predetermined period with the one or more parts of the uniformly formatted time series data to provide results of the SUT which represent the at least one invariant over the state of the SUT.

12. The system of claim 9, wherein individual ones of the different InaC source code comprise keys for one of the respective preconditions and input conditions, and wherein the keys comprise cyclic keys which comprise first values of the uniformly formatted time series data which are continuously provided in the test procedures and comprise acyclic keys which comprise second values of the uniformly formatted time series data which are periodically provided in the test procedures.

13. One or more circuits to verify a system-under-test (SUT) using execution of one or more compiled versions of different invariants-as-code (InaC) source code from a library and using one or more parts of uniformly formatted time series data from the SUT performing test procedures in a test environment, the verification to generate results of the SUT which represent at least one invariant which is continuous over a state of the SUT.

14. The one or more circuits of claim 13, wherein the one or more circuits is further to provide an application programming interface (API) through which to receive a configuration file which maps parts of the uniformly formatted time series data with different invariant features of the different InaC source code.

15. The one or more circuits of claim 14, wherein the one or more circuits is further to provide an application programming interface (API) through which to receive the uniformly formatted time series data to perform the verification of the SUT, wherein the verification uses the configuration file and the uniformly formatted time series data in the test environment which performs the execution of the one or more compiled versions of the different InaC source code.

16. A method for a system-under-test (SUT), the method comprising:
providing a library comprising different invariants-as-code (InaC) source code to be complied for verifying the SUT, the different InaC source code comprising different invariant features defined at least by respective preconditions and input conditions;
enabling the SUT to perform test procedures executed within a test environment to provide differently formatted data;
generating uniformly formatted time series data from the differently formatted data; and
executing one or more compiled versions of the different InaC source code with one or more parts of the uniformly formatted time series data to provide results of the SUT which represent at least one invariant which is continuous over a state of the SUT.

17. The method of claim 16, wherein individual ones of the different InaC source code comprise a verify function to verify a given method comprising the respective preconditions and input conditions using a follow-on method which specifies a further condition representative of an SUT response to at least one of the input conditions of the respective preconditions and input conditions.

18. The method of claim 16, wherein the different InaC source code are continuously used over a predetermined period with the one or more parts of the uniformly formatted time series data to provide results of the SUT which represent the at least one invariant over the state of the SUT.

19. The method of claim 16, wherein individual ones of the different InaC source code comprise keys for one of the respective preconditions and input conditions, and wherein the keys comprise cyclic keys which comprise first values of the uniformly formatted time series data which are continuously provided in the test procedures and comprise acyclic keys which comprise second values of the uniformly formatted time series data which are periodically provided in the test procedures.

20. The method of claim 16, wherein the respective preconditions and input conditions are associated with assertions in one or more keys and correspond to events in the uniformly formatted time series data, and wherein the execution of the one or more compiled versions of the different InaC source code with one or more parts of the uniformly formatted time series data is to provide the results of the SUT by a verification of data of the assertions against values from the events.
